(19) United States
(12) Patent Application Publication
(10) Pub. No.: US 2004/0262982 A1
(43) Pub. Date: Dec. 30, 2004

(54) Stopper

(76) Inventor: Antonio Varrone, Leederville (AU)

Correspondence Address: LADAS & PARRY, 26 WEST 61ST STREET, NEW YORK, NY, 10023, US

(21) Appl. No.: 10/489,066

(22) PCT Filed: Sep. 27, 2002
(86) PCT No.: PCT/AU02/01332

(30) Foreign Application Priority Data
Sep. 27, 2001 (AU) PR7952

(51) Int. Cl. B60B 1/02

(52) U.S. Cl. 301/58

(57) ABSTRACT

A stopper (10) is characterised by a bearing member (12) and a base member. The base member is projecting from a lower surface of the bearing member (12). The base member is proportioned to be received within a spoke access hole (30) of a wheel rim (34).

### FIELD OF THE INVENTION

The present invention relates to a stopper. More particularly, the stopper of the present invention is intended for use with spoked-wheel rims.

### BACKGROUND ART

Historically, spoked-wheel rims have required a barrier to protect the inner tube of the tyre from being scuffed or punctured by spoke nipple heads, and particularly by protruding threaded spoke ends. The barrier typically employed was known as “rim tape” such rim tape was originally cotton tape, but progressed though rubber strip to synthetic materials also.

The introduction of hollow rims having recessed spoke nipples still requires use of a rim tape. This is due to the need to provide access holes in the peripheral surface of the rim, the portion of the rim contacting the inner tube of the tyre, as otherwise the inflated inner tube can extend into the access holes and may be scuffed or cut on sharp edges of those access holes drilled in the peripheral surface of the rim.

The rim tape that is used to cover the access holes can be required to withstand pressures of up to 10 bar. Not surprisingly, most (if not all) rim tapes “cup” to varying extents under such pressure, some actually yielding due to material failure or as a result of their being cut by the shape edges of the drilled access holes.

In addition, if it is necessary to access a spoke nipple, the entire adhesive-backed and expensive rim tape needs to be removed from the rim. Once removed, the rim tape is typically discarded. The removed rim tape may be reapplied, but does not generally locate well and loses some of its support properties, thereby increasing the chance of its failure and a blowout.

The present invention has as one object thereof to substantially overcome the abovementioned problems associated with the prior art, or to at least provide a useful alternative thereto.

The preceding discussion of the background art is intended to facilitate an understanding of the present invention only. It should be appreciated that the discussion is not an acknowledgement or admission that any of the material referred to was part of the common general knowledge in Australia as at the priority date of the application.

Throughout the specification, unless the context requires otherwise, the word “comprise” or variations such as “comprises” or “comprising”, will be understood to imply the inclusion of a stated integer or group of integers but not the exclusion of any other integer or group of integers.

### DISCLOSURE OF THE INVENTION

In accordance with the present invention there is provided a spoke access hole stopper characterised by a bearing member and a base member, the base member projecting from a lower surface of the bearing member, the base member being proportioned to be received and retained within a spoke access hole of a wheel rim such that a tube can not press or blow through that spoke access hole.

Preferably, the bearing member is provided with a substantially smooth upper surface. The bearing member may be contoured in a manner complementary to the peripheral surface of the wheel,. rim to which it may be fitted.

Still preferably, the bearing member and base member are integrally formed.

In one form of the invention the bearing member is substantially elliptical in plan and is hollowed-out along a longitudinal axis thereof.

Preferably, the base member is to some extent flexibly resilient so as to resist fitting to, or removing from, the spoke access hole.

In one form of the base member is provided in the form of four quarter segments extending from the lower surface such that the diameter of the base member may be compressed. An outermost end of the base member may have provided thereabout an annular rim. The annular rim being arranged to engage the rim around the spoke access hole.

### BRIEF DESCRIPTION OF THE DRAWINGS

The stopper of the present invention will now be described, by way of example only, with reference to one embodiment thereof and the accompanying drawings, in which:

FIG. 1 is a first perspective view of a stopper in accordance with the present invention;

FIG. 2 is a second perspective view of the stopper of FIG. 1;

FIG. 3 is a planned view of the stopper of FIGS. 1 and 2 shown fitted to a spoke access hole of a rim; and

FIG. 4 is a cross-sectional end view of the stopper of FIGS. 1 and 2 fitted to a spoke access hole of a rim.

### BEST MODE(S) FOR CARRYING OUT THE INVENTION

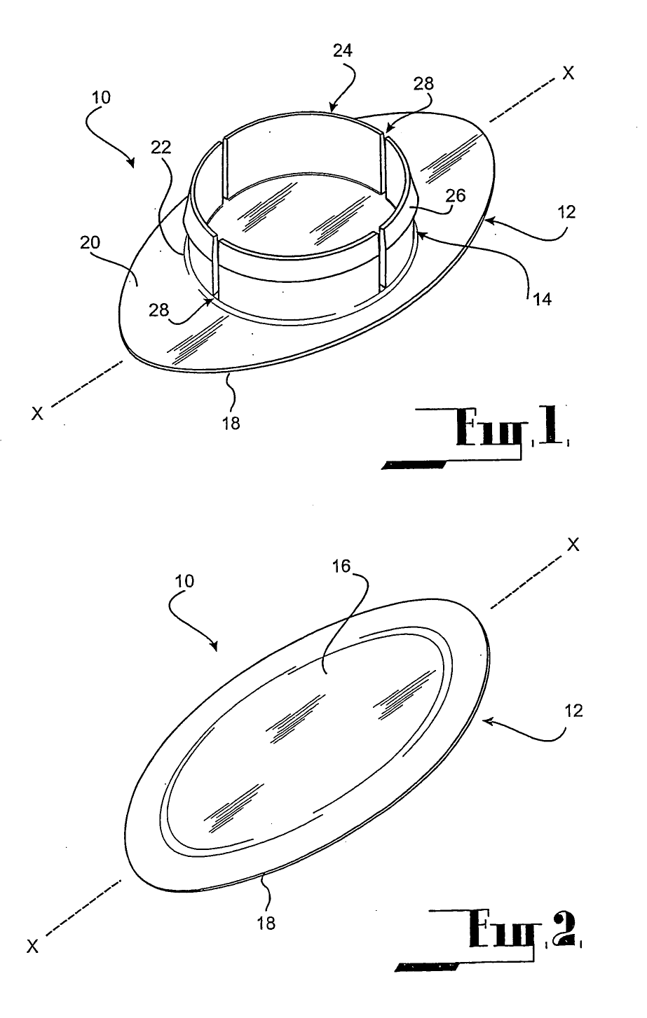

In FIGS. 1 and 2 there is shown a stopper 10 comprising a bearing member 12 and a base member 14. The bearing member 12 is of substantially elliptical form in plan view, describing a longitudinal axis X-X. The bearing member 12 is curved upwardly and outwardly along the X-X axis, as can be seen with reference to FIG. 2, or is what may be described as “hollowed-out” along that axis. A peripheral edge 18 of the upper surface 16 is chamfered.

The base member 14 is substantially cylindrical in form and projects from a lower surface 20 of the bearing member 12 in a generally central location, as best seen in FIG. 1. The base member 14 comprises a neck portion 22 and an outermost end 24, the outermost end 24 having provided thereat an annular rim 26.

The base member 14 has four slits 28 provided therein and extending the length thereof, dividing the base member 14 into quarters. This allows some compression of the base member 14 to reduce its circumference at the outer most end 24.

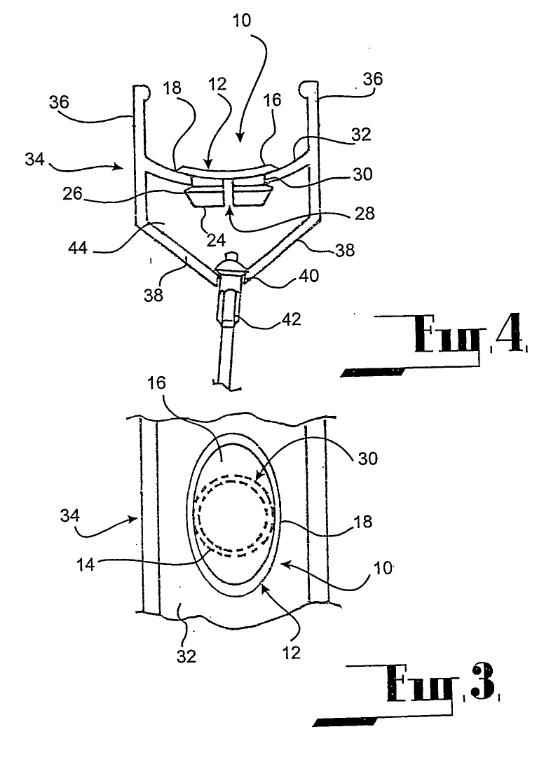

In FIGS. 3 and 4 the stopper 10 is shown in position in a spoke access hole 30 in a generally concave peripheral wall 32 of a hollow wheel rim 34.

The hollow wheel rim 34 comprises side walls 36 that converge to form inner walls 38, at an apex of which spoke holes 40 are provided to receive a nipple and spoke 42. The concave peripheral wall 32 extends between the side walls 36 and thereby defines a hollow chamber 44.

In use, the stopper 10 is fitted to the spoke access hole 30 by a user positioning the base member 14 above the spoke access hole 30 and pushing downwardly on the bearing member 12, so as to push the base member 14 through the spoke access hole 30. In this process the base member 14 compresses to allow the outermost end 24 and rim 26 of the base member 14 to pass through the spoke access hole 30. Once the rim 26 has passed through the spoke access hole 30 the base member 14 springs outwardly to its original position, the annular rim 26 thereby engaging the wall 32 and actively retaining the stopper 10 within the spoke access hole 30.

The stopper 10 is orientated to have its X-X axis positioned along the concave or channel defined by the peripheral wall 32, as can be seen with reference to FIGS. 3 and 4, thereby minimising any opportunity for the stopper 10 to rotate within the spoke access hole 30.

The chamfered edge 18 sits substantially flush with the wall 32, thereby presenting a substantially smooth surface to a tube that may press against the stopper 10 during use, thereby protecting the tube from any sharp edges of the spoke access hole 30 and preventing the tube blowing through that hole.

To allow access for a user to a spoke and nipple 42 the stopper 10 of the appropriate spoke access hole 30 may be levered from the spoke access hole 30. Once any necessary work has been conducted a further stopper 10 can be fitted as described hereinabove. As such, if there is a problem with a single spoke and nipple 42 only a single stopper 10 need be removed, rather than removing and replacing a complete rim tape as may be required with prior art arrangements. The use of stoppers in accordance with the present invention should also provide a weight advantage when compared with the use of rim tape of the prior art, particularly if the stoppers 10 are moulded of a plastics material.

The stopper 10 may be moulded from plastics materials, although other materials may prove suitable. It is envisaged that the base member may be formed of alternate materials with some inherent resilience, for example rubber. In addition, the lower surface 20 of the bearing member 12 may be provided with an adhesive to more positively locate the stopper 10 with respect to the wall 32.

Modifications and variations such as would be apparent to the skilled addressee are considered to fall within the scope of the present invention.

1. A spoke access hole stopper characterised by a bearing member and a base member, the base member projecting from a lower surface of the bearing member, the base member being proportioned to be received and retained within a spoke access hole of a wheel rim such that a tube can not press or blow through that spoke access hole.

2. A stopper according to claim 1, characterised in that the bearing member has a substantially smooth upper surface.

3. A stopper according to claim 1, characterised in that the bearing member is contoured in a manner complimentary to the peripheral surface of the wheel rim to which it may be fitted.

4. A stopper according to claim 1, characterised in that the bearing and base members are formed integrally.

5. A stopper according to claim 1, characterised in that the bearing member is substantially elliptical in plan and is hollowed-out along a longitudinal axis thereof.

6. A stopper according to claim 1, characterised in that the base member is to some extent flexibly resilient so as to resist fitting to, or removal from, the spoke access hole.

7. A stopper according to claim 1, characterised in that the base member is provided in the form of four quarter segments extending from the lower surface such that the diameter of the base member may be compressed.

8. A stopper according to claim 1, characterised in that an outermost end of the base member has provided thereabout an annular rim.

9. A stopper according to claim 2, characterised in that the bearing member is contoured in a manner complimentary to the peripheral surface of the wheel rim to which it may be fitted.

10. A stopper according to claim 2, characterised in that the bearing and base members are formed integrally.

11. A stopper according to claim 3, characterised in that the bearing and base members are formed integrally.

12. A stopper according to claim 2, characterised in that the bearing member is substantially elliptical in plan and is hollowed-out along a longitudinal axis thereof.

13. A stopper according to claim 3, characterised in that the bearing member is substantially elliptical in plan and is hollowed-out along a longitudinal axis thereof.

14. A stopper according to claim 4, characterised in that the bearing member is substantially elliptical in plan and is hollowed-out along a longitudinal axis thereof.
